(19) United States
(12) Patent Application Publication
(10) Pub. No.: US 2009/0151097 A1
(43) Pub. Date: Jun. 18, 2009

(54) Attachment Device for a Sewer Pipe Cleaning System

(75) Inventor: Ilija Tanevski, New South Wales (AU)

Correspondence Address: THE NATH LAW GROUP, 112 South West Street, Alexandria, VA, 22314, US

(73) Assignee: Sydney Water Corporation, Sydney (AU)

(21) Appl. No.: 11/991,930

(22) PCT Filed: Sep. 13, 2006
(86) PCT No.: PCT/AU2006/001344

§ 371 Date: May 20, 2008

(30) Foreign Application Priority Data
Sep. 14, 2005 (AU) 2005905077

(51) Int. Cl. B08B 9/00

(52) U.S. Cl. 15/104.095

(57) ABSTRACT

There is disclosed an attachment device for attaching a pipe cleaning tool to a rotary motion facilitation device. The pipe cleaning tool comprises an elongate member adapted to be received by the rotary motion facilitation device. The attachment device comprises a connecting element that is positionable to connect the elongate member to said rotary motion facilitation device such that rotary motion can be transferred from the rotary motion facilitation device to the pipe cleaning tool. A retainer element is mountable to the rotary motion facilitation device to enclose at least a portion of the connecting element to retain the connecting element in position.

### CROSS-REFERENCE TO RELATED APPLICATIONS

The present application claims priority from Australian Provisional Patent Application No 2005905077 filed on 14 Sep. 2005, the content of which is incorporated herein by reference.

### FIELD OF THE INVENTION

The present invention relates generally to sewer pipe blockage removal systems for clearing blockages in sewer pipes, and in particular to a device for attaching together the parts of such systems.

### BACKGROUND ART

Wastewater removal systems generally include a plurality of underground pipelines or sewer lines which deliver wastewater from a property connection to a treatment facility. Regular maintenance of the system is fundamental to provide a safe and effective waste management system, as blockages in the sewer line can cause contamination of properties with raw sewage.

Typically, regular maintenance of the systems comprises monitoring the network of pipes to remove, and prevent the build-up of, blockages in the pipes. It has been found that a large majority of blockages are caused by root intrusion, which in some instances can cause pipes to become fractured, thereby resulting in soil and groundwater contamination. Similarly, sewer blockages can also be caused by a build-up of grease and the like in the pipes, and as such regular clearing/cleaning of the pipes is necessary.

A process known as rodding has been the traditional process for maintaining and clearing pipes in water supply and sewage systems. Generally, the process involves inserting lengths of metal rods into the pipe to be cleared, with a cutter or similar tool attached to the free end of the rods. The cutter may be in the form of a corkscrew cutter which is rotated as it is fed through the pipe thereby cutting the blockage (such as a tree root mass) causing the blockage to break-up and pass through the pipes as the fluid flow resumes.

A variety of automated systems have been proposed to perform this task, from rotatably driven rodding devices provided on a feed reel for storing and feeding the rods, to high pressure cleaners (jetters) which pump water at a high pressure through the pipes directed at the blockage to displace the blockage from the pipe. In such systems however, convenient access to the pipes is required to employ the automated system. Also, such systems require a readily available power source to perform the tasks which may not be available in remote or difficult to access sites.

Typically, in remote or difficult to access sites, the rodding process is performed manually by a team of operators, typically a team of three. In this regard, one operator may be positioned at the manhole, or entrance of the pipe, to assemble and push the rods into the pipe, whilst two operators may be provided with rod turning ratchets, which grip the rods to impart rotary motion to the rods, and subsequently the cutter, to enable the cutter to perform a cutting action. The ratchets typically fit over the rods and are connected to the rods by a connecting pin arrangement, such that rotation of the ratchet in one direction causes the rod to rotate in the same direction.

It has been found that in such arrangements, as the clearing event takes place well beneath the surface of the ground and far from the operator(s), it takes a considerable amount of experience for the operators to determine how much torsional pressure should be applied to the rod without causing breakage and/or damage to the tools, together with injury to the operators. In particular, it has been found that during operation, the rods apply significant torsional forces to the cutter such that when the cutter actually breaks through the blockage, it spins at speed to release the energy associated with the build-up of forces. This free spinning of the cutter after it passes through the blockage creates a reaction force in the rods, causing the rods to spin in a reverse direction, thereby generating a torsional force in the rods which is transferred to the rod turning ratchets. At this point, it has been found that this force is borne by the connecting pin arrangement connecting the rods to the ratchet which can cause the connecting pin arrangement to detach from the ratchets and become airborne thereby having a potential to cause injury to the operator(s), or other individuals in the general area, and/or to cause damage to surrounding structures, such as buildings, vehicles and the like.

In this regard, there is a need to provide a sewer cleaning or blockage removal system that can be employed in remote or difficult to access sites and/or which is able to withstand a relatively high degree of torsional forces without causing unwanted detachment of the components of the system.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

According to a first aspect, the present invention is an attachment device for attaching a pipe cleaning tool to a rotary motion facilitation device, said pipe cleaning tool comprising an elongate member adapted to be received by said rotary motion facilitation device, the attachment device comprising:

a connecting element positionable to connect said elongate member to said rotary motion facilitation device such that rotary motion can be transferred from the rotary motion facilitation device to said pipe cleaning tool; and

a retainer element mountable to said rotary motion facilitation device to enclose at least a portion of said connecting element.

In one embodiment the connecting element is a pin and is positionable to pass through at least a portion of the elongate member and the rotary motion facilitation device. The elongate member and the rotary motion facilitation device may have one or more recesses formed therein to receive the pin. The recesses formed in the elongate member and the rotary motion facilitation device may be aligned to receive the pin which passes orthogonally therethrough. The recesses may be holes or bores formed through the elongate member and the rotary motion facilitation device. In such an arrangement, rotational motion of the rotary motion facilitation device is transferred to the elongate member through the pin.

In one form, the pin may comprise an elongate body extending between a proximal end and a distal end. The elongate body may have a head portion at the proximal end. The head portion may have a diameter greater than the diameter of the elongate body to prevent the pin from passing through the one or more recesses formed in the elongate member and the rotary motion facilitation device. The elongate body may be configured such that it's cross-sectional profile substantially conforms to the holes/bores provided through the elongate member and the rotary motion facilitation device to allow the pin to be received within the holes/bores. In this embodiment, the pin may be relatively snugly received within the holes bores. In this regard, the pin may be configured such that it when it is positionable to connect the elongate member to the rotary motion facilitation the head portion and the distal end of the elongate body are located external of the elongate member and the rotary motion facilitation device. In such an arrangement, the body of the pin extends through the holes/bores formed in the rotary motion facilitation device and the elongate member such that the head portion and an end of the cylindrical elongate body, opposed to said head portion end, are exposed.

In another embodiment, the retainer element has a substantially tubular body comprising a tubular wall extending between an open proximal end and an open distal end. The proximal end of the retainer element may be mountable to the rotary motion facilitation device to retain the connecting element in position. A first recess and a second recess may be formed in the tubular wall of the retainer element. The first and second recesses may be formed in laterally opposed regions of the tubular wall. The first and second recesses may define first and second channels formed in the tubular wall of the retainer element. The first and second channels may be formed such that they are open at the proximal end of the tubular body and extend to a stop region located remote from the proximal end of the tubular body. The first and second channels may be configured to receive the elongate body of the pin when the pin is received in the one or more recesses formed in the elongate member and the rotary motion facilitation device.

The proximal end of the retainer element may be mountable to the rotary motion facilitation device such that the elongate body of the pin adjacent the distal end is received within the opening of the second channel, whilst the elongate body of the pin adjacent the head portion is received within the opening of the first channel. By rotating the retainer element, the received portions of the cylindrical elongate body of the pin can travel along the channels to the end region of the channels, thereby being positioned at the stop position.

In another embodiment, a spring element is provided within the tubular body of the retainer element to bias the received portions of the cylindrical elongate body of the pin into the stop positions. In this regard, the spring element may be a compression spring having a central bore portion which may be attached to the retainer element at the distal end. In such an arrangement, when the retainer element is mountable to the rotary motion facilitation device, the spring element contacts a surface of the rotary motion facilitation device to provide a force that urges the retainer element away from the surface of the rotary motion facilitation device. This in turn causes the received portions of the pin to be captured in the stop positions.

In yet another embodiment, the retainer element comprises a skirt member that extends from the tubular wall of the retainer element. The skirt portion may extend a distance from the substantially tubular body to define an enclosed space which is open at the proximal end of the retainer element. In one form, the skirt member is arranged to extend about the first channel to provide an enclosed space extending beyond the wall surrounding the channel. In this arrangement, the skirt member may be arranged to provide a space which receives the head portion of the pin when the retainer element is mountable to the rotary motion facilitation device.

The retainer element may be mountable to the rotary motion facilitation device such that the elongate member passes through the open proximal and distal ends of the retainer element. In this regard, the elongate member can pass through the central bore of the spring element. In such an arrangement, the elongate member is able to freely rotate without interference from the retainer element.

According to another aspect, the present invention is a system for removing blockages in a sewer pipe, comprising:

an elongate member insertable into said pipe and having a proximal end and a distal end;

a pipe cleaning tool attachable to the distal end of the elongate member and being configured to physically contact and release said blockage;

a rotary motion facilitation device configured to receive the proximal end of the elongate member;

a connecting element positionable to connect said elongate member to said rotary motion facilitation device such that rotary motion can be transferred from the rotary motion facilitation device to said pipe cleaning tool; and

a retainer element mountable to said rotary motion facilitation device to enclose at least a portion of said connecting element.

According to either of the first or second aspects, in one embodiment the rotary motion facilitation device is a ratchet tool which can be manually or otherwise manipulated to apply rotational motion to the elongate member. In another embodiment, the rotary motion facilitation device may be a motor.

In another embodiment of the first and second aspects of the invention, the elongate member may comprise one or more elongate rod elements connected in an end-to-end arrangement. In this regard, the length of the elongate member may be readily adapted to accommodate a large variety of lengths of pipes.

In yet another embodiment of the second aspect of the invention, the pipe cleaning tool may be a corkscrew cutter device. In this regard, the rotary motion applied by the rotary motion facilitation device to the elongate member is transferred to the corkscrew cutter device to perform a cutting motion which removes and releases the blockage from the pipe. In another form, the blockage removal tool may be a brush or the like.

According to the second aspect of the invention, the connecting element and the retainer element may be as described in relation to the first aspect of the invention.

### BRIEF DESCRIPTION OF THE DRAWINGS

FIG. 1A shows an exploded view of an attachment device according to one embodiment of the present invention together with the rotary motion facilitation device;

FIG. 1B shows a plurality of elongate members used which comprise part of a pipe cleaning tool to be used with the attachment device of the FIG. 1A;

FIG. 1C shows a cleaning tool which is attachable to the elongate members as shown in FIG. 1B to form the pipe cleaning tool;

FIG. 2 depicts a prior art pipe blockage removal system incorporating a flexible pin retainer clip;

FIG. 3 depicts a connector element for connecting adjacent rods of the pipe blockage removal system of FIG. 1;

FIG. 4 depicts a retainer element of one embodiment of the present invention; and

FIGS. 5a-5d depict various views of the retainer element of FIG. 4.

### DETAILED DESCRIPTION OF AN EXEMPLARY EMBODIMENT OF THE PRESENT INVENTION

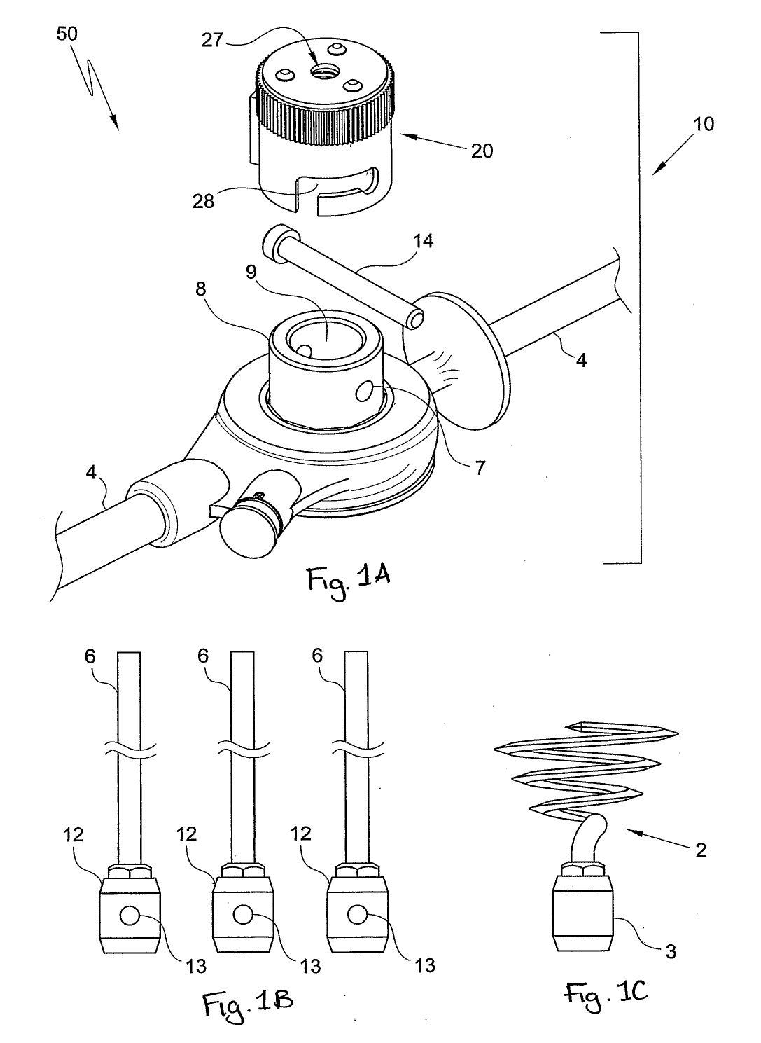

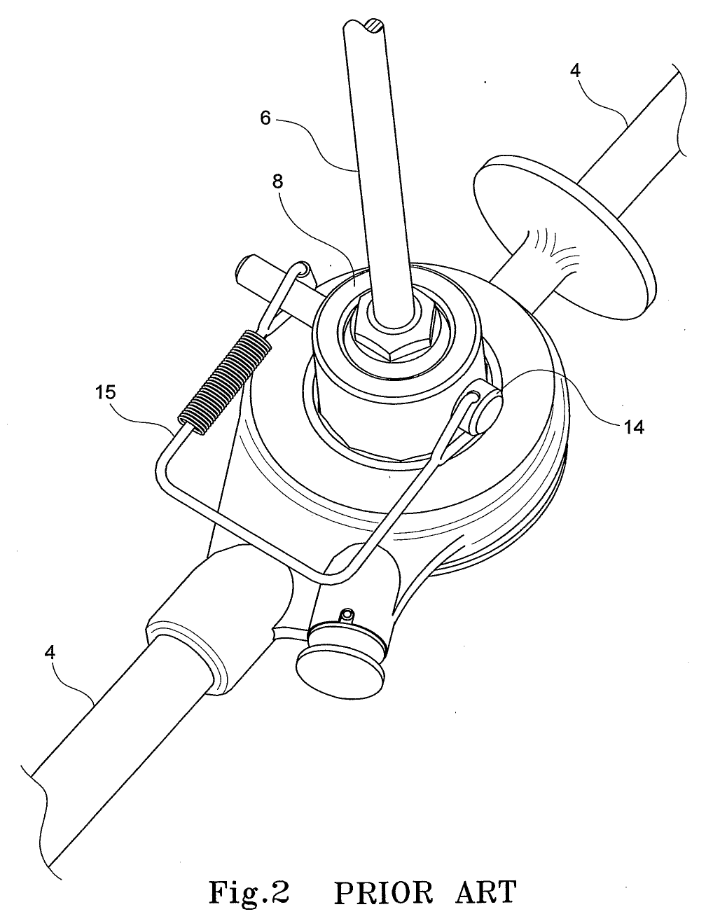

FIGS. 1A-1C shows the various components of the sewer pipe blockage removal system of the present invention. The pipe blockage removal system as shown is a manually operated system, commonly referred to as a rodding system, however it will be appreciated that the present invention is equally applicable to power operated systems whereby the torsional forces are applied to the system by a motor or the like.

As shown, the system generally comprises a cleaning tool 2, in the form of a cutting element, such as a corkscrew cutter, brush or the like. The cleaning tool 2 is sized and configured to be inserted into a pipe and rotated, such that the blades/brushes of the tool 2 make a cutting action as they progress through the pipe. In this regard, as the tool 2 comes into contact with solid matter blocking the pipe, such as roots or the like, the tool 2 cuts and breaks up the matter thereby releasing the matter and resuming fluid flow in the pipe.

The cleaning tool 2 has a connector element 3 arranged at an end thereof which enables the tool 2 to be connected to an end of an elongate member or rod 6, for insertion into the pipe to be cleared. One or more rod(s) 6 may be used with the blockage removal system with each rod 6 being connectable at its end to adjacent rods thereby allowing multiple rods to be connected together lengthwise such that the depth to which the cleaning tool 2 can be inserted into the pipe can vary depending on the length of the pipe, and the position of the blockage in the pipe.

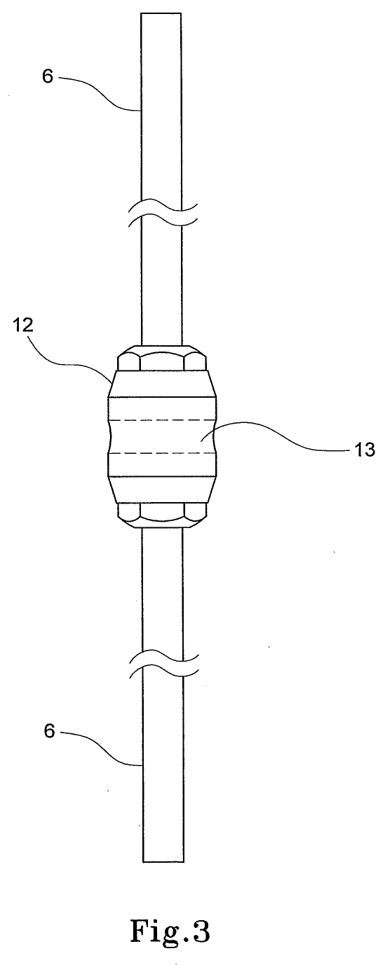

The rod(s) 6 are steel rods, such as spring steel, which are able to be connected together in a daisy-chain via a connector element 12 provided at an end thereof. The other end of the rod 6 is free, enabling the connection to the cleaning tool 2 or a connector element 12 of an adjacent rod 6, as will be discussed in relation to FIG. 3 below. When assembled, each rod(s) is inserted into the pipe to the desired position such that the cleaning tool 2 can contact the blockage in the pipe. In this regard, by imparting rotational motion to the rod(s), the cleaning tool 2 is able to rotate in a cutting action as it is further inserted into the pipe, thereby cutting or physically breaking down the blockage to restore fluid flow through the pipe.

At least one ratchet tool 10 is provided to impart the rotational motion to the rod(s) 6 to provide the cutting action of the system 50. The ratchet tool 10 comprises a pair of handles 4 which enable the operator to grip the tool 10 with both hands. Centrally located between the handles 4 is a ratchet element 8 having an axially located hole 9 extending therethrough. The hole 9 is configured to receive the rod(s) 6 to enable the rod(s) 6 to be gripped by the tool 10 to impart rotational motion thereto.

As shown more clearly in relation to FIG. 3, in order to attach the rod(s) 6 to the ratchet tool 10 such that rotation of the tool 10 can cause rotational motion of the rod(s) 6, the connector element 12 which connects the rods 6 has a recess 13 extending therethrough. The recess 13 is arranged orthogonal to the length of the rod(s) 6, and is sized to receive a pin 14.

As is shown in FIG. 1A, the ratchet element 8 is in the form of a cylindrical tube rotationally mounted within the tool 10 such that it is free to rotate in a first direction but prevented from rotation in an opposite direction. A portion of the ratchet element 8 extends from a surface of the tool 10 and has a pair of diametrically opposed holes 7 formed therethrough, which are able to receive the pin 14.

In this regard, in order to secure the rod(s) 6 to the tool 10 such that rotational motion can be imparted to the rod(s) 6 to operate the associated cleaning tool 2, the rod(s) 6 are positioned such that the recess 13 provided in the connector element 12 comes into alignment with the opposed holes 7 formed through the ratchet element 8. The pin 14 is then inserted through the holes 7 and recess 13 to provide a secure connection between the rods 6 to the ratchet element 8.

As will be appreciated, any rotational motion applied to the ratchet tool 10, either manually or by way of a motor, is transferred to the rod(s) 6 through the pin 14. In this regard, the pin 14 is made from a rigid steel or alloy, such as brass, which is capable of withstanding a substantially large torsional force without undergoing deformation or fracture. As the pin 14 provides the sole connection between the rod(s) 6 and the ratchet tool 10, it is important that the pin 14 is secured in position to enable the system 50 to function as described.

FIG. 2, shows a prior art arrangement for securing the pin 14 in position to ensure effective operation of the rodding system 50. In this arrangement, a flexible clip arrangement 15 is provided to prevent the pin 14 from becoming dislodged from the rods 6 and the ratchet element 8. As shown, the clip arrangement 15 is in the form of a flexible U-shaped clip which is pivotally secured at a first end to the head of the pin 14 and has a free second end arranged to fit over and capture a free end of the pin 14 thereby preventing the pin 14 from sliding out of the ratchet element 8. In order to remove the pin 14 from the ratchet element 8, should the system 50 require disassembly or lengthening by way of the addition of further rod(s) 6, the clip arrangement 15 is sufficiently flexible to enable the free second end of the clip arrangement to be removed, by hand, from the free end of the pin 14, to allow the pin 14 to slide from the holes 7 and recess 13, disconnecting the rod(s) 6 and the ratchet element 8. To enable this action, the body of the U-shaped clip comprises a spring portion, and/or is made from suitably resilient material.

It will be appreciated that in use, the ratchet tool 10 can be employed to impart rotational motion to the rods 6, and subsequently the cleaning tool 2, by gripping the handles 4 and rotating the tool 10 about the central axis of the ratchet element 8. In this regard, as the rod(s) 6 are fed into the pipe such that the cleaning tool 2 comes into contact with the blockage, the rotational motion of the cleaning tool 2 assists in breaking-up and removing the blockage, causing the fluid in the pipe to flow again.

Typically, as the cleaning tool 2 breaks through the blockage, it spins due the large amount of torsional force stored in the rod(s) 6. A reaction force is then generated in the rod(s) 6 causing them to spin in a reverse direction. This reaction force is then applied at the point of contact between the rod(s) 6 and the ratchet tool 10, namely at the pin 14, which receives a relatively large and almost instantaneous torsional force in the opposite direction. In the prior art arrangement as shown in FIG. 2, wherein the pin is retained in position by the flexible clip arrangement 15, it has been found that the resultant forces can be sufficient to cause the flexible body of the clip arrangement 15 to flex away from the pin 14 thereby releasing the pin 14 which can be thrown from the ratchet tool 10 as an air borne projectile which has the potential to cause significant injury to the operator(s) and surrounding people/property.

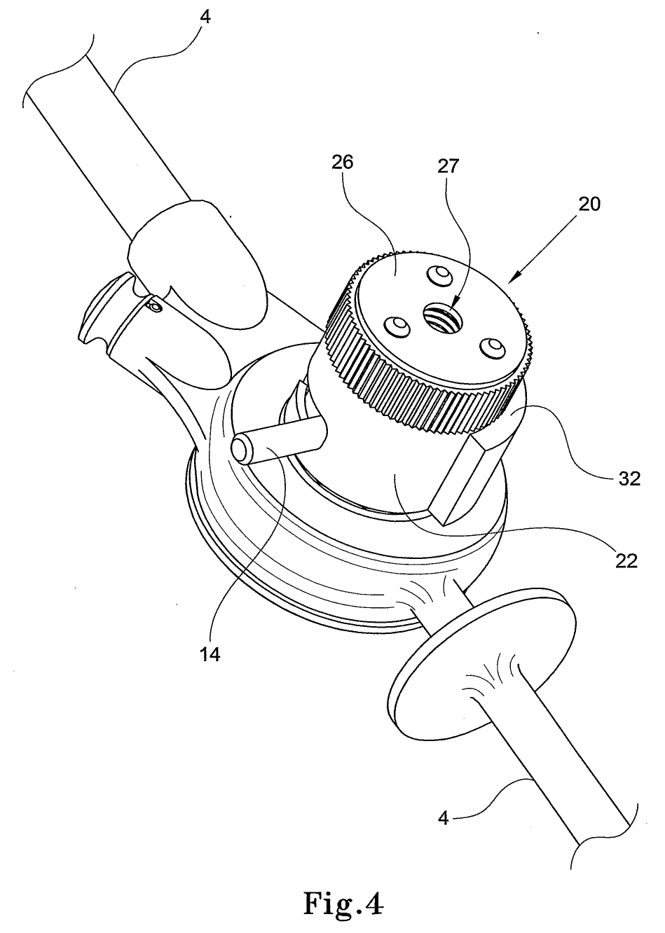

In order to overcome this problem and to securely retain the pin 14 in position during such events, a retainer element 20, as shown in FIG. 1A, is provided. The retainer element 20 is arranged to fit over the ratchet head 8 and the pin 14, to form an enclosed system, as is shown in FIG. 4.

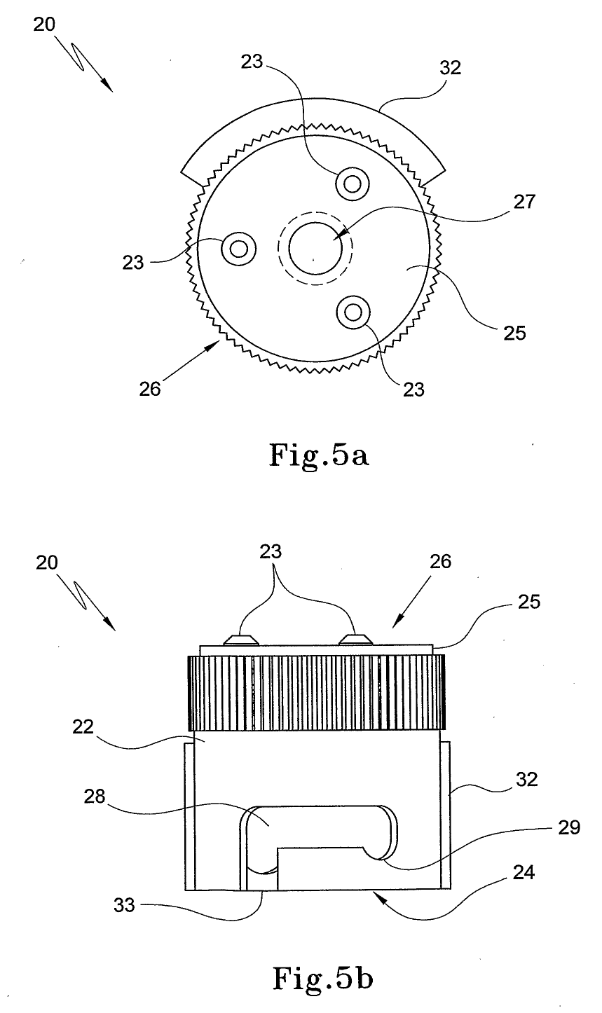

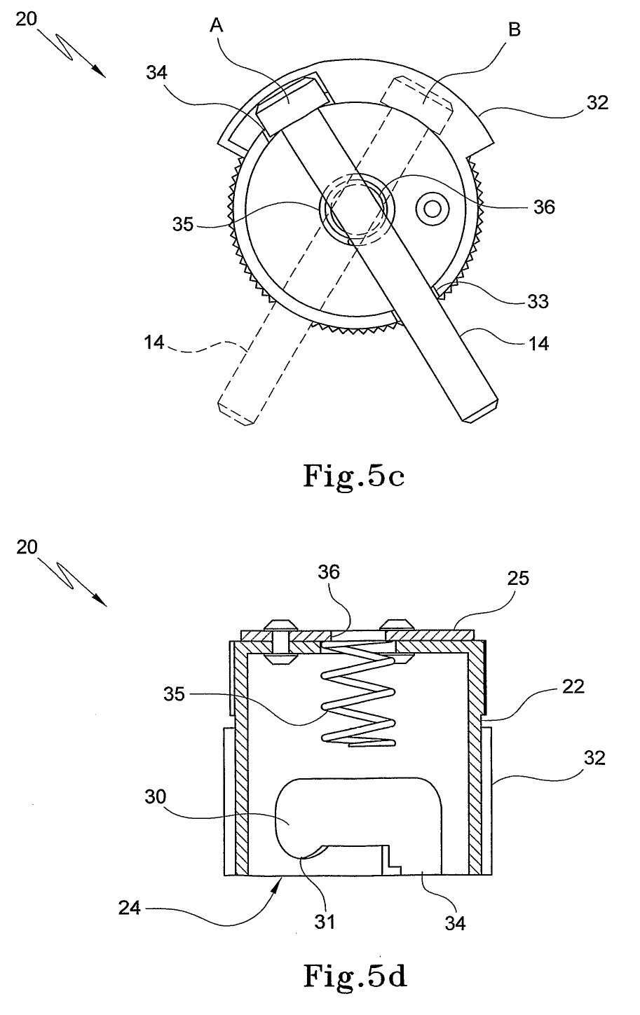

FIGS. 5a-5d show various views of the retainer element 20 of FIGS. 1 and 4. The retainer element 20 has a substantially cylindrical body 22 having a first open end 24 adapted to fit over the ratchet element 8, and a second end 26 having a restricted opening 27 formed therein. In this regard, the restricted opening 27 allows the rod(s) 6, as shown in FIGS. 1 and 2, to pass therethrough en-route to the interior of the pipe to be cleared.

The restricted opening 27 is provided in an end plate 25 which is attached to the end 26 of the cylindrical body 22 by way of rivets 23, as shown in FIGS. 5A and 5B. Such an arrangement allows the end plate 25 to be removed from the end 26 of the retainer element to provide access to the inner portion of the retainer element 20, as will be discussed below. Whilst the end plate 25 has been shown to be fixed to the cylindrical body 22 by way of rivets 23, it will be appreciated that other securing means, such as screws or the like, could also be employed to facilitate easy removal thereof.

As shown in FIG. 5B, a portion of the wall of the cylindrical body 22 is removed thereby defining a channel or passage 28 for receiving and locating the body of the pin 14 when the retainer element 20 is secured in position. The passage or channel 28 formed in the wall of the cylindrical body 22 is provided with an opening 33 which defines an entry position for receiving the shaft of the pin 14, and a stop 29 which defines a final locking position for the retainer element, as will be described in more detail below. As the retainer element 20 is made from a stainless steel or other similar heavy duty metal, the channel or passage 28 can be removed from the wall thereof without greatly affecting the structural integrity of the element 20.

A similar channel or passage 30 is formed in the wall of the cylindrical body 22, substantially diametrically opposed to the channel or passage 28, and which predominately mirrors the channel or passage 28, as shown in FIG. 5D. As will be discussed in more detail below, the channel or passage 30 is provided to receive the region of the pin 14 proximal to the head of the pin and is provided with an opening 34 which defines an entry position for receiving the pin 14, and a stop 31 which defines a final locking position of the retainer element, which corresponds with the final locking position associated with stop 29 discussed above.

A skirt 32 is provided attached to and extending from the cylindrical body 22 of the retainer element 20 in the region surrounding the channel or passage 30. The skirt 32 defines an enclosed space in which the head of the pin 14 is accommodated when the retainer element 20 is positioned on the ratchet element 8 during use, thereby preventing removal of the pin 14.

The manner in which the skirt 32, and the channels or passages 28 and 30 interact to secure the retainer element 20 in position about the pin 14 and the ratchet element 8 is shown in relation to FIG. 5C.

In use, the rod(s) 6 are firstly assembled to a desired length and the cleaning tool 2 is attached to the end thereof. The rod(s) 6 are then inserted into the pipe through a manhole such that the cleaning tool 2 is able to contact the blockage. The retainer element 20 is then firstly inserted over the end of the rod(s) 6, namely the end opposite to which the cleaning tool 2 is attached, and the ratchet tool 10 is then slid onto the end of the rod(s) 6 behind the retainer element 20. The pin 14 is then inserted through the holes 7 formed in the ratchet element 8 and through the aligned recess 13 provided in the connector element 12 of the rod(s) 6, thereby providing a connection between the rod(s) 6 and the ratchet tool 10.

The retainer element 20, is then lowered over the ratchet element 8 and the pin 14, such that the neck of the pin 14, namely the region of the pin immediately below the head of the pin, is received in the opening 34 of the channel 30 and the shaft of the pin 14 adjacent its end, is received in the opening 33 of the channel 28. This position is shown as position A in FIG. 5C.

In order to secure the retainer element 20 in place, the retainer element is rotated to position B, as shown in FIG. 5C, wherein the neck of the pin is received in stop 31 and the shaft of the pin is received in stop 29. In this position, the head of the pin 14 is fully retained within the skirt 32, which defines a locking position for the retainer element 20.

As shown in the cross sectional view of the retainer element 20 of FIG. 5D, to bias the retainer element into the locking position B and to ensure that the pin is securely retained in this position even in the event of high torsional forces, a spring element 35 is centrally disposed within the cylindrical body 22 of the retainer element 20. The spring element is shown as a compression spring, however it will be appreciated that other types of resilient members could also be employed.

The spring element 35 contacts the end plate 25 provided in the end 26 of the cylindrical body 22 and is provided with a central bore 36 which substantially correspond with the restricted opening 27 provided in the end 26. In this regard, the central bore 36 of the spring element 35 provides a passage through which the rod(s) 6 pass through the cylindrical body 22.

Upon positioning the retainer element 20 over the pin 14 and ratchet element 8, the spring element 35 contacts with upper surface of the ratchet element 8 generating a biasing force urging the retainer element 20 away from the ratchet element 8. Therefore, as the body of the pin 14 is received within the openings 33 and 34 (Position A in FIG. 5C), the operator pushes against the action of the spring element 35 and rotates the element 20 into the locking position (Position B of FIG. 5C). In this position, the spring element 35 acts to urge the pin into the stops 29 and 31 respectively thereby securely locking the retainer element 20 in position over the ratchet element 8 and the pin 14, preventing inadvertent removal of the pin during use. As the stops 29 and 31 are disposed above the openings 33 and 34, as shown in FIGS. 5B and 5D, the spring element 35 is in a constant state of compression which aids in locking the retainer element 20 in position.

As will be appreciated, as the head of the pin 14 is enclosed within the skirt 32 of the retainer element 20, there is provided a safe and contained connection between the ratchet tool 10 and the rod(s) 6. Such an arrangement ensures that in the event of a significant change/reversal in torsional forces within the system 50, as is discussed above, the connection between the ratchet tool 10 and the rod(s) 6 is maintained and the pin 14 is securely contained, thereby reducing the likelihood of the pin being flung from the system 50 as a missile. In this regard, the system 50 provides a safe and reliable system for performing sewage maintenance and pipe cleaning, particularly in remote or difficult to access areas.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An attachment device for attaching a pipe cleaning tool to a rotary motion facilitation device, said pipe cleaning tool comprising an elongate member adapted to be received by said rotary motion facilitation device, the attachment device comprising:
a connecting element positionable to connect said elongate member to said rotary motion facilitation device such that rotary motion can be transferred from the rotary motion facilitation device to said pipe cleaning tool; and
a retainer element mountable to said rotary motion facilitation device to enclose at least a portion of said connecting element.

2. An attachment device according to claim 1, wherein the connecting element is a pin and is positionable to pass through at least a portion of the elongate member and the rotary motion facilitation device.

3. An attachment device according to claim 2, wherein the elongate member and the rotary motion facilitation device have one or more recesses formed therein to receive the pin.

4. An attachment device according to claim 3, wherein the one or more recesses formed in the elongate member and the rotary motion facilitation device are aligned to receive the pin.

5. An attachment device according to claim 3, wherein the pin comprises an elongate body extending between a proximal end and a distal end, said elongate body having a head portion at the proximal end.

6. An attachment device according to claim 5, wherein the head portion has a diameter greater than the elongate body to prevent the pin from passing through the one or more recesses formed in the elongate member and the rotary motion facilitation device.

7. An attachment device according to claim 6, wherein the pin is configured to be received in the one or more recesses formed in the elongate member and the rotary motion facilitation device such that the head portion and the distal end of the elongate body are located external of the elongate member and the rotary motion facilitation device.

8. An attachment device according to claim 7, wherein the retainer element has a substantially tubular body having an open proximal end and a distal end.

9. An attachment device according to claim 8, wherein the proximal end of the retainer element is mountable to the rotary motion facilitation device.

10. An attachment device according to claim 9, wherein a first recess and a second recess are formed in the walls of the tubular body.

11. An attachment device according to claim 10, wherein the first recess and second recess are laterally opposed.

12. An attachment device according to claim 11, wherein the first and second recesses define a first and a second channel through the walls of the tubular body.

13. An attachment device according to claim 12, wherein the first and second channels are open at the proximal end of the tubular body and extend to a stop region located remote from the proximal end of tubular body.

14. An attachment device according to claim 13, wherein the first and second channels are configured to receive the elongate body of the pin when the pin is received in the one or more recesses formed in the elongate member and the rotary motion facilitation device.

15. An attachment device according to claim 14, wherein the proximal end of the retainer element is mountable to the rotary motion facilitation device such that the elongate body of the pin adjacent the distal end of the pin is received within the opening of the second channel, whilst the elongate body of the pin adjacent the head portion is received within the opening of the first channel.

16. An attachment device according to claim 15, wherein the retainer element is rotatable into a locked position, whereby the elongate body of the pin adjacent the free end of the pin is received within the stop region of the second channel, whilst the elongate body of the pin adjacent the head portion is received within the stop region of the first channel.

17. An attachment device according to claim 16, wherein a spring element is provided within the tubular body of the retainer element to bias the retainer element into the locked position.

18. An attachment device according to claim 16, wherein a skirt member extends from a wall of the tubular body of the retainer element proximal the first channel.

19. An attachment device according to claim 18, wherein the skirt member extends substantially the length of the first channel and is recessed from the wall of the tubular body to define an open space between the tubular body and the skirt member.

20. An attachment device according to claim 19, wherein the open space is configured to accommodate the head portion of the pin when the retainer element is mountable to the rotary motion facilitation device.

21. An attachment device according to claim 20, wherein the retainer element is mountable to the rotary motion facilitation device such that the elongate member of the pipe cleaning tool passes through the tubular body of the retainer element.
